(19) United States
(12) Patent Application Publication
(10) Pub. No.: US 2004/0146045 A1
(43) Pub. Date: Jul. 29, 2004

(54) Communication scheme for preventing attack by pretending in service using anycast

(75) Inventors: Tatsuya Jimmei, Kawasaki-shi (JP); Masahiro Ishiyama, Fuchu-shi (JP); Yuzo Tamada, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/705,976

(22) Filed: Nov. 13, 2003

(30) Foreign Application Priority Data
Nov. 13, 2002 (JP) 2002-329950

(51) Int. Cl. H04L 12/28

(52) U.S. Cl. 370/351

(57) ABSTRACT

In the communication system, the filtering is realized at times of transmission and reception, by a server which attaches an identifier indicating an anycast address to a source address of a response packet, a communication device which detects the identifier indicating an anycast address in the response packet and verifies the response packet, when the source address is different from the destination address, and a boundary router which detects the identifier in the packet and verifies that the response packet is a response transmitted from the server, according to information regarding servers that is stored in advance.

### BACKGROUND OF THE INVENTION

1. Field of the Invention

The present invention-relates to a communication device, a boundary router device, a server device, a communication system, a communication method, a routing method, a communication program and a routing program for preventing a response pretending in an environment using anycast address of the IPv6.

2. Description of the Related Art

In recent years, the use of the Internet which is a world's largest computer network has been widespreading, and new computer businesses have been developed by utilizing disclosed information or service by accessing the Internet or conversely providing information or service to an external user who accesses the Internet.

Also, new techniques to be utilized on the Internet have been developed actively. In the Internet, each connected computer (node, server, etc.) has an identifier called IP address, and the communications are carried out by exchanging packets according to this IP address.

As fat as the IP address format is concerned, the address system of 32 bits length called IPv4 has been used, but in recent years there is a transition to a new address system of 128 bits length called IPv6.

One of the features of the IPv6 is the introduction of anycast address. The anycast address is utilized similarly as a unicast address on the routing control, but it is assigned to a plurality of interfaces on a plurality of nodes unlike the unicast address.

Consequently, a packet transmitted to an anycast address from some node will be delivered to a closest node on the route. Even if a malfunctioning occurs at a node to which the anycast address is assigned. it is possible to realize an automatic switching to the next best router which has the same address after the routing information converges.

By assigning the existing anycast address to a plurality of servers which are providing some service by utilizing such characteristics of the anycast address, it is possible to realize a highly redundant service without requiring a special setting or change to the end-host.

However, there is a limitation that the anycast of the IPv6 cannot be used as a source address. Consequently, a server which received a packet destined to the anycast address needs to use an own unicast address as a source address at a time of returning a response.

Here, in general, in the case of utilizing the anycast address, it becomes easier to receive an attack from a malicious third party by the pretending. For a client terminal which transmits a packet destined to the anycast address, it is impossible to learn in advance the unicast address of a server which is to return a response, so that it must accept a response packet no matter what source address it has.

For this reason, there has been a problem that the client terminal would accept a response even if it is actually a response by the illegal pretending from a node which has no right to provide a service.

Also, in the service using the unicast address, there is a simple verification method such as that which compares the source of the response packet with the destination of an inquiry packet, for example, and it has been actually in use.

But this cannot be a complete verification because it is easy to falsify the source address. It is however possible to some extent to narrow down a range from which an attack can be received, by using a filtering for verifying the properness of the source address at a router at a boundary of the network, for example.

But in the case of using the anycast address, it is possible to return an illegal response without falsifying the source address, so that there has been a problem that a possibility for receiving an attack from a malicious third party by the pretending becomes higher than the case of using the unicast address (see IETF RFC2460, Internet Protocol, Version 6 (IPv6) Specification, December 1998).

As described above, in the service using the anycast address of the IPv6, because there is a limitation that the anycast address cannot be used as a source address of a source that has that anycast address, there has been a problem that it is difficult to verify the properness of the source.

In this case, there has been a danger that a possibility for receiving an attached by the pretending, as a malicious third party is altering the source address, becomes higher than the case of using the unicast address.

### BRIEF SUMMARY OF THE INVENTION

It is therefore an object of the present invention to provide a communication device, a boundary router device, a server device, a communication system, a communication method, a routing method, a communication program and a routing program for preventing a damage due to the pretending, by enabling a verification of the properness of the source in the service using the anycast address.

According to one aspect of the present invention there is provided a communication device, comprising: a transmission unit configured to transmit a packet to a prescribed destination address; a reception unit configured to receive a response packet for responding to the packet transmitted by the transmission unit; a first detection unit configured to detect a source address contained in the response packet received by the reception unit; a second detection unit configured to detect an identifier indicating that an anycast address is assigned to another communication device that has the prescribed destination address, which is contained in the response packet, when the source address detected by the first detection unit and the prescribed destination address are different; and a verification unit configured to verify the response packet, according to the identifier detected by the second detection unit.

According to another aspect of the present invention there is provided a boundary router device located at a boundary between a first network to which a server device having an anycast address belongs and a second network, comprising: a first reception unit configured to receive a packet destined to the server device, from a communication device on the second network; a first transfer unit configured to transfer the packet to the server device; a second reception unit configured to receive a response packet for responding to the packet, from the server device; a detection unit configured to detect an identifier indicating that a source address different from the anycast address is attached, which is contained in the response packet; a verification unit configured to verify that the response packet is a response transmitted from the server device, according to information regarding server devices having the anycast address in the second network which are provided in advance, when the identifier is detected by the detection unit; a transfer control unit configured to control whether or not to transfer the response packet to the communication device, according to a verification result of the verification unit; and a second transfer unit configured to transfer the response packet to the communication device, when the transfer control unit judges that the response packet should be transferred.

According to another aspect of the present invention there is provided a server device connected to a first network and having an anycast address, comprising: a reception unit configured to receive a packet transmitted to the anycast address, from a communication device connected to a second network; an identifier attaching unit configured to attach to a response packet for responding to the packet an identifier indicating that a source of the response packet has the anycast address; and a transmission unit configured to transmit the response packet to the communication device.

According to another aspect of the present invention there is provided a communication system, comprising: a server device connected to a first network and having an anycast address; a communication device connected to a second network; and a boundary router device located at a boundary between the first network and the second network; wherein the communication device has: a first transmission unit configured to transmit a packet to the anycast address; and a first reception unit configured to receive a response packet for responding to the packet from the server device; the server device has: a second reception unit configured to receive the packet transmitted to the anycast address from the communication device; an identifier attaching unit configured to attach to the response packet for responding to the packet a first identifier indicating that the server device has the anycast address; and a second transmission unit configured to transmit the communication device to the response packet; and the boundary router device has: a third reception unit configured to receive the packet destined to the server device from the communication device; a first transfer unit configured to transfer the packet to the server device; a fourth reception unit configured to receive the response packet for responding to the packet from the server device; a detection unit configured to detect a second identifier indicating that a source address different from the anycast address is attached, which is contained in the response packet; a verification unit configured to verify that the response packet is a response transmitted from the server device, according to information regarding server devices having the anycast address in the first network which is provided in advance, when the second identifier is detected by the detection unit; a transfer control unit configured to control whether or not to transfer the response packet to the communication device, according to a verification result of the verification unit; and a second transfer unit configured to transfer the response packet to the communication device, when the transfer control unit judges that the response packet should be transferred.

According to another aspect of the present invention there is provided a communication method at a communication device, comprising: transmitting a packet to a prescribed destination address; receiving a response packet for responding to the packet; detecting a source address contained in the response packet; detecting an identifier indicating that an anycast address is assigned to another communication device that has transmitted the response packet, which is contained in the response packet, when the source address and the prescribed destination address are different; and verifying the response packet, according to the identifier.

According to another aspect of the present invention there is provided a routing method at a boundary router device located at a boundary between a first network to which a server device having an anycast address belongs and a second network, comprising: receiving a packet destined to the server device, from a communication device on the second network; transferring the packet to the server device; receiving a response packet for responding to the packet, from the server device; detecting an identifier indicating that a source address different from the anycast address is attached, which is contained in the response packet; verifying that the response packet is a response transmitted from the server device., according to information regarding server devices having the anycast address in the second network which are provided in advance, when the identifier is detected; controlling whether or not to transfer the response packet to the communication device, according to a verification result; and transferring the response packet to the communication device, when it is judged that the response packet should be transferred.

According to another aspect of the present invention there is provided a communication method at a server device connected to a first network and having an anycast address, comprising: receiving a packet transmitted to the anycast address, from a communication device connected to a second network; attaching to a response packet for responding to the packet an identifier indicating that the server device has the anycast address; and transmitting the response packet to the communication device.

According to another aspect of the present invention there is provided a computer program product for causing a computer to function as a communication device, the computer program product comprising: a first computer program code for causing the computer to transmit a packet to a prescribed destination address; a second computer program code for causing the computer to receive a response packet for responding to the packet; a third computer program code for causing the computer to detect a source address contained in the response packet; a fourth computer program code for causing the computer to detect an identifier indicating that an anycast address is assigned to another communication device that has transmitted the response packet, which is contained in the response packet, when the source address and the prescribed destination address are different; and a fifth computer program code for causing the computer to verify the response packet, according to the identifier.

According to another aspect of the present invention there is provided a computer program product for causing a computer to function as a routing method at a boundary router device located at a boundary between a first network to which a server device having an anycast address belongs and a second network, the computer program product comprising: a first computer program code for causing the computer to receive a packet destined to the server device, from a communication device on the second network; a second computer program code for causing the computer to transfer the packet to the server device; a third computer program code for causing the computer to receive a response packet for responding to the packet, from the server device; a fourth computer program code for causing the computer to detect an identifier indicating that a source address different from the anycast address is attached, which is contained in the response packet; a fifth computer program code for causing the computer to verify that the response packet is a response transmitted from the server device, according to information regarding server devices having the anycast address in the second network which are provided in advance, when the identifier is detected; a sixth computer program code for causing the computer to control whether or not to transfer the response packet to the communication device, according to a verification result; and a seventh computer program code for causing the computer to transfer the response packet to the communication device, when it is judged that the response packet should be transferred.

According to another aspect of the present invention there is provided a computer program product for causing a computer to function as a communication method at a server device connected to a first network and having an anycast address, comprising, the computer program product comprising: a first computer program code for causing the computer to receive a packet transmitted to the anycast address, from a communication device connected to a second network; a second computer program code for causing the computer to attach to a response packet for responding to the packet an identifier indicating that the server device has the anycast address; and a third computer program code for causing the computer to transmit the response packet to the communication device.

Other features and advantages of the present invention will become apparent from the following description taken in conjunction with the accompanying drawings.

### BRIEF DESCRIPTION OF THE DRAWINGS

FIG. 1 is a schematic block diagram showing a configuration of a communication system according to one embodiment of the present invention.

FIG. 2 is a schematic block diagram showing a configuration for carrying out anycast address communication according to one embodiment of the present invention.

FIG. 3 is a block diagram showing a configuration of a communication device according to one embodiment of the present invention.

FIG. 4 is a block diagram showing a configuration of a boundary router device according to one embodiment of the present invention.

FIG. 5 is a block diagram showing a configuration of a server device according to one embodiment of the present invention.

FIG. 6 is a flow chart showing a communication method of the communication device according to one embodiment of the present invention.

FIG. 7 is a flow chart showing a routing method of the boundary router device according to one embodiment of the present invention.

FIG. 8 is a flow chart showing a communication method of the server device according to one embodiment of the present invention.

FIG. 9 is a flow chart showing a communication method of the communication system according to one embodiment of the present invention.

### DETAILED DESCRIPTION OF THE INVENTION

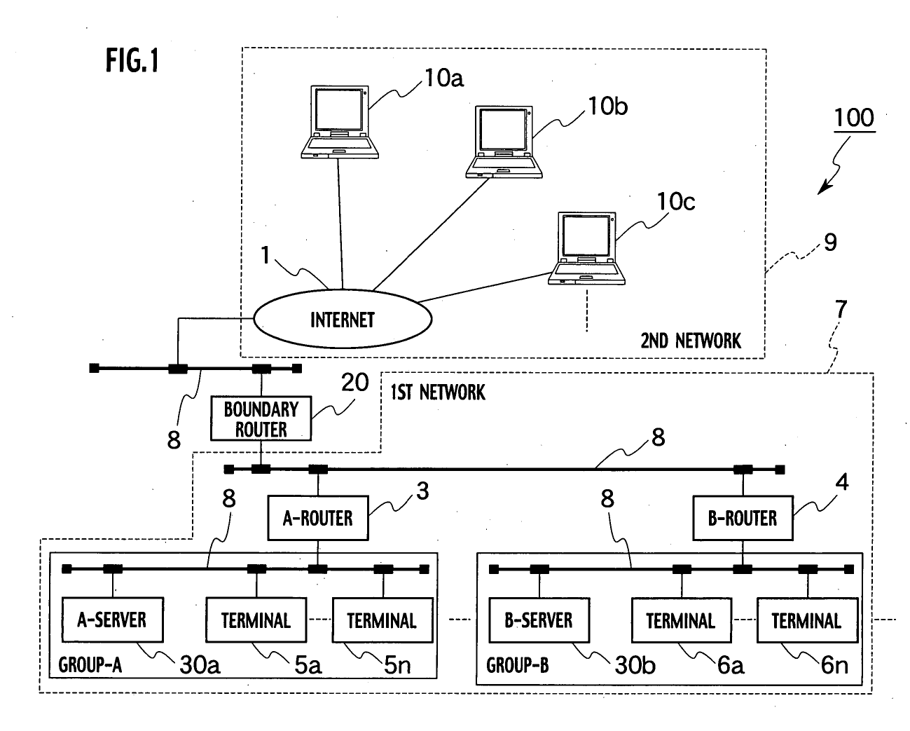

Referring now to FIG. 1 to FIG. 9, one embodiment of the present invention will be described in detail.

(Communication System)

First, an outline of a network and a communication system using the anycast address will be described, As shown in FIG. 1, a communication system 100 comprises communication devices 10a, 10b, 10c, etc. and an Internet 1 which are located inside a second network 9, a boundary router 20 which is provided between a first network 7 which is an internal network and the second network 9, an A-router 3 and a B-router 4 which are located inside the first network 7, an A-server 30a and terminals 5a to 5n which are belonging to the first network, and a B-server 30b and terminals 6a to 6n which are belonging to the first network 7.

The Internet 1 is a communication channel for connecting the first network 7 and the second network 9. This communication channel may be realized by a dedicated channel connected by cables or the like, a long distance radio communication such as a satellite communication, or a short distance radio communication such as Bluetooth.

The A-router 3 and the B-router 4 are devices for routing packets on a network layer, which carry out the data transfer between any nodes on the first network 7. The A-server 30a is a computer for carrying out processing and functioning as a center of nodes managed by the A-router 3. The B-server 30b is a computer for carrying out processing and functioning as a center of nodes managed by the B-router 4.

As shown in FIG. 1, the nodes subordinate to the A-router 3 include the A-server 30a and terminals 5a, 5b and 5c. Also, the nodes subordinate to the B-router 4 include the B-server 30b and terminals 6a, 6b and 6c. All devices of the first network 7 are connected through LAN cables 8.

Note that devices of the communication devices 10a, 10b, 10c, etc., the boundary router 20, A-server 30a and B-server 30b are realized by installing software programs for realizing prescribed functions to general purpose computers.

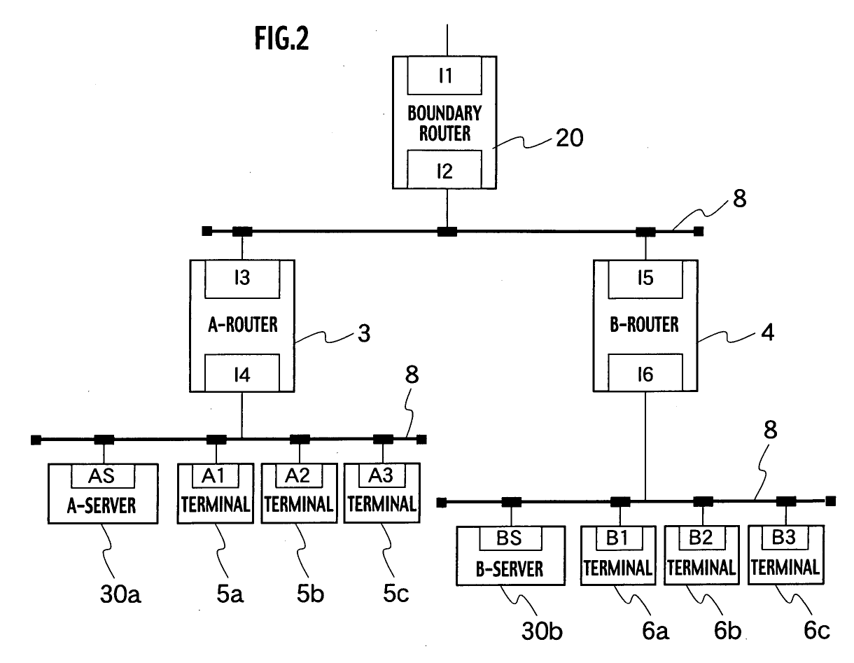

Also, interfaces of all the devices are assigned with interface addresses (which are assumed to be IPv6 addresses here) as shown in FIG. 2. Here, the physical layer of the LAN cable 8 is the Ethernet™, and it is assumed that the IPv6 address is assigned to it. Each IPv6 address in 128 bits is automatically generated by generating an interface identifier in 64 bits by using the MAC address assigned to the own interface, and setting the interface identifier as the lower 64 bits and a prefix received from a router as the upper 64 bits.

The forms of the IPv6 addresses include link local addresses and global addresses, but all the addresses used here are assumed to be global addresses.

A manager who manages a network belonging to the boundary router 20 assigns an identical anycast address S to the interfaces of the A-server 30a and the interfaces of the B-server 30b. A packet destined to the anycast address will be delivered to the interface having that anycast address which is closest on routes.

Here, it is assumed that each one of the A-router 3 and the B-router 4 already knows whether the anycast address is assigned to the nodes belonging to the own router or not. For example, the A-router 3 stores a table indicating that the A-server 30a has the anycast address S. Similarly, the B-router 4 stores a table indicating that the B-server 30b has the anycast address S. These tables may be manually set up by the manager described above, or may be set up automatically by using some protocol between a router and a server.

(Communication Device)

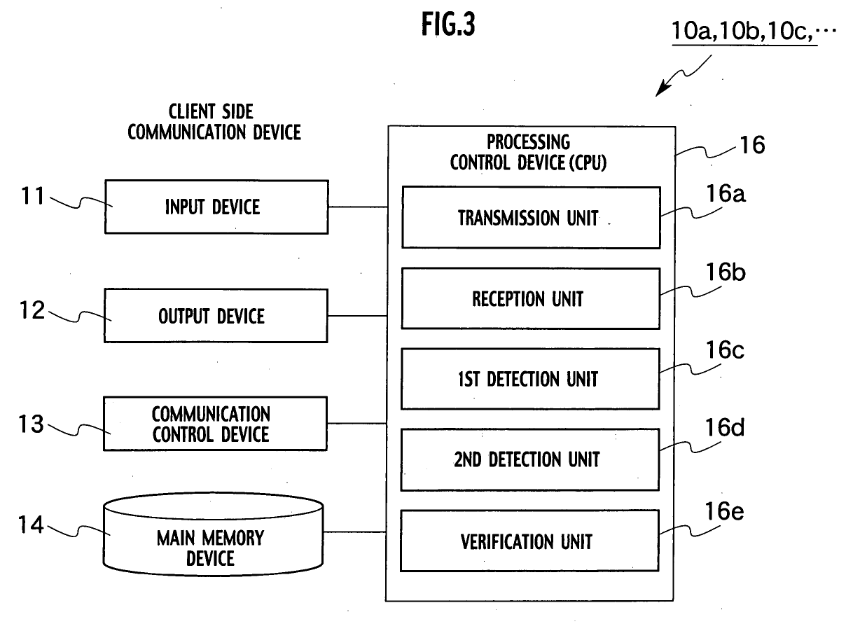

Each one of the communication devices 10a, 10b, 10c, etc., shown in FIG. 1 has a configuration shown in FIG. 3, which has an input device 11, an output device 12, a communication control device 13, a main memory device 14, and a processing control device (CPU) 16. The CPU 16 has a transmission unit 16a, a reception unit 16b, a first detection unit 16c, a second detection unit 16d and a verification unit 16e.

The transmission unit 16a is a module for checking a destination address in a header of the packet, and transmitting the packet to that destination address. The reception unit 16b is a module for receiving a response packet that is transmitted from a server or the like to which the packet was transmitted, as a response to the packet.

The first detection unit 16c is a module for detecting a source address contained in the received response packet. The second detection unit 16d is a module for detecting an identifier indicating the anycast address contained in the source address, in the case where the detected source address is different from the destination address. The verification unit 16e is a module for verifying the response packet according to the identifier.

The input device 11 is formed by a keyboard, mouse, etc. It is also possible to enter inputs from an external device through the communication control device 13. Here, the external device is a memory medium such as CD-ROM, MO, or ZIP and its drive device. The output device 12 is formed by a display device such as liquid crystal display or CRT display, a printing device such as an ink-jet printer or laser printer, etc.

The communication control device 13 is a module for generating control signals for transmitting or receiving data through a communication channel to the other device, server, etc. The main memory device 14 temporarily stores the data to be processed and a program describing a procedure of the processing, and gives the machine commands of the program and the data according to a request from the CPU 16. The data processed by the CPU 16 is written into the main memory device 14. The main memory device 14 and the CPU 16 are connected by an address bus, a data bus, control signals, etc.

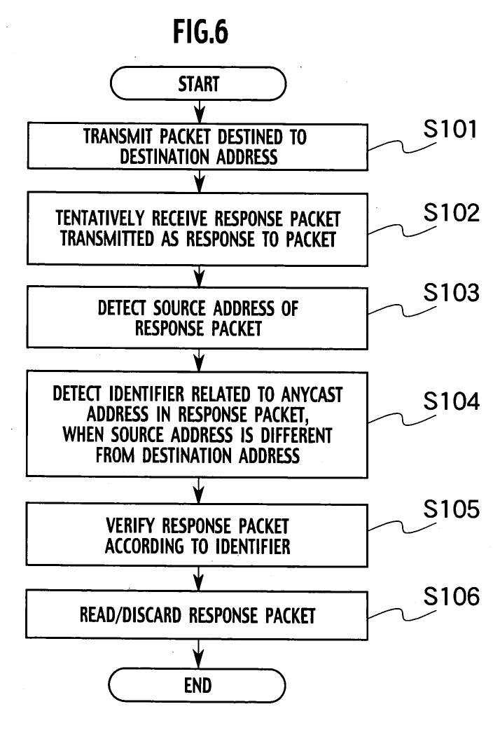

(Communication method using the communication devices) Next, the communication method using the communication devices 10a, 10b, 10c, etc. will be described with references to FIG. 1, FIG. 3 and FIG. 6.

(a) At the step S101, the transmission unit 16a shown in FIG. 3 checks the destination address in the header of the packet, and transmits the packet to that destination address. The packet is transmitted to the destination address through the Internet shown in FIG. 1.

A correspondent device such as a server which received the packet transmits a response packet for this packet toward the communication devices 10a, 10b, 10c, etc. At a time of this transmission, the correspondent device such as a server attaches to the response packet an identifier for proving the anycast address to which this device belongs.

(b) At the step S102, the reception unit 16b receives the response packet transmitted from the correspondent device such as a server, as a response to the packet.

(c) At the step S103, the first detection unit 16c detects the source address contained in the response packet received by the reception unit 16b. As a result, it becomes possible to identify the correspondent that is at the source.

(d) At the step S104, in the case where the detected source address is different from the destination address, the second detection unit 16d detects the identifier indicating the anycast address contained in the source address.

(e) At the step S105, the verification unit 16e verifies that the correspondent device such as a server that is at the source is not pretending, according to the detected identifier.

In this way, by detecting the identifier indicating the anycast address communication at the communication devices 10a, 10b, 10c, etc., the security at the equivalent level as the unicast address can be secured for the anycast address.

(Boundary Router)

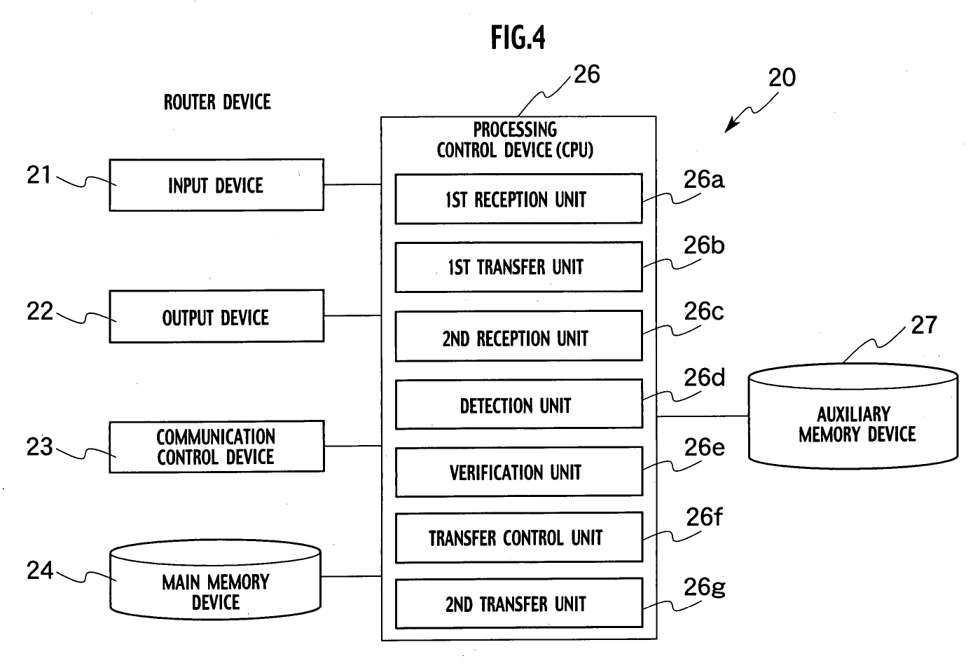

As shown in FIG. 1, the boundary router 20 is located at a boundary between the first network 7 to which a plurality of server devices having the anycast address belong and the second network 9 which is an external network. As shown in FIG. 4, the boundary router 20 is formed by an input device 21, an output device 22, a communication control device 23, a main memory device 24, a processing control device (CPU) 26 and an auxiliary memory device 27.

The auxiliary memory device 27 stores addresses of interfaces within the first network 7. The CPU 26 has a first reception unit 26a, a first transfer unit 26b, a second reception unit 26c, a detection unit 26d, a verification unit 26e, a transfer control unit 26f, and a second transfer unit 26g. The first reception unit 26a is a module for receiving packets destined to the plurality of server devices having the anycast address, from the communication devices 10a, 10b, 10c, etc. on the second network 9 side.

The first transfer unit 26b is a module for transferring the packet to a server device which is closest on routes among the plurality of server devices having the anycast address. The second reception unit 26c is a module for receiving the response packet for the packet, from the server device that is closest on routes.

The detection unit 26d is a module for detecting an identifier indicating that the source address different from the anycast address is attached, which is contained in the response packet. The verification unit 26e is a module for verifying that the response packet is a response packet transmitted from one server device among the plurality of server devices having the anycast address, in the case where the identifier is detected by the detection unit 26d.

The transfer control unit 26f is a module for controlling whether or not to transfer the response packet to the communication devices 10a, 10b, 10c, etc. The second transfer unit 26g is a module for transferring the response packet to the communication devices 10a, 10b, 10c, etc., according to the control of the transfer control unit 26f.

The input device 21, the output device 22, the communication control device 23, and the main memory device 24 are similar to those of the communication devices 10a, 10b, 10c, etc., so that their description will be omitted here.

(Routing Method)

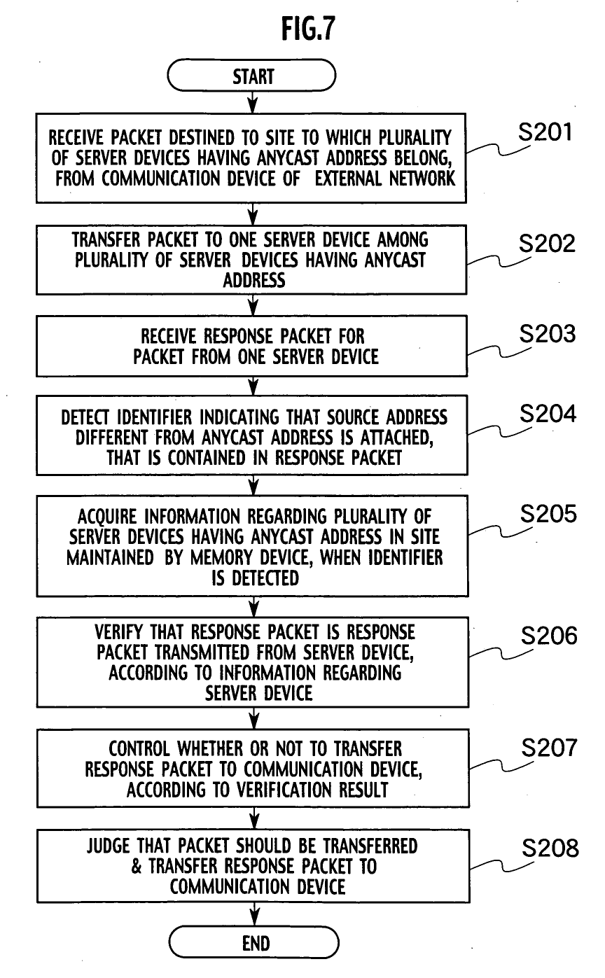

Next, the routing method using the boundary router 20 will be described with reference to FIG. 7.

(a) At the step S201, the first reception unit 26a receives the packet destined to the server devices having the anycast address, from the communication devices 10a, 10b, 10c, etc. on the client side of FIG. 1.

(b) At the step S202, the first transfer unit 26b transfers the received packet to one server device that is closest on routes among the server devices having the anycast address. In the case of FIG. 1, the packet is transferred to the A-server 30a.

(c) At the step S203, the second reception unit 26c receives the response packet from the A-server 30a, which is a response to the packet.

(d) At the step S204, the detection unit 26d detects the identifier indicating that the source address different from the anycast address is attached, which is contained in the response packet.

(e) At the step S205, the verification unit 26e verifies that the response packet is a response packet transmitted from one server device among the plurality of server devices having the anycast address, in the case where the identifier is detected by the detection unit 26d.

(f) At the step S207, the transfer control unit 26f controls whether or not to transfer the response packet to the communication devices 10a, 10b, 10c, etc.

When it is judged that the response packet should be transferred, at the step S208, the second transfer unit 26g transfers the response packet to the communication devices 10a, 10b, 10c, etc., according to the control of the transfer control unit 26f. On the other hand, when it is judged that the response packet should not be transferred, the response packet is discarded.

According to the above described processing, by carrying out the filtering of the identifier indicating the anycast address communication at the boundary router 20, the security at the equivalent level as the unicast address can be secured for the anycast address.

(Server Devices Having the Anycast Address)

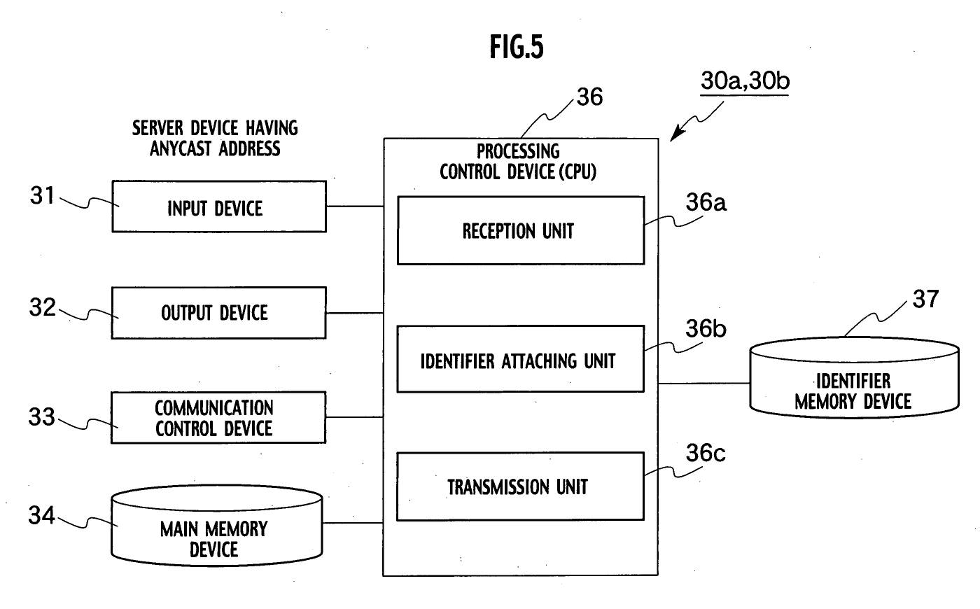

As shown in FIG. 5, each one of the A-server 30a and the B-server 30b which are the server devices having the anycast address is formed by an input device 31, an output device 32, a communication control device 33, a main memory device 34, a processing control device (CPU) 36 and an identifier memory device 37.

The identifier memory device 37 stores an identifier indicating that this server device has the anycast address.

The CPU 36 has a reception unit 36a, an identifier attaching unit 36b, and a transmission unit 36c. The reception unit 36a is a module for receiving a packet transmitted to the anycast address from the communication devices 10a, 10b, 10c, etc. that are connected to the second network 9.

The identifier attaching unit 36b is a module for attaching the identifier indicating that this server device has the anycast address, to the source address of the response packet for responding to the packet. The transmission unit 36c is a module for transmitting the response packet to the communication devices 10a, 10b, 10c, etc.

The input device 31, the output device 32, the communication control device 33, and the main memory device 34 are similar to those of the communication devices 10a, 10b, 10c, etc., so that their description will be omitted here.

(Communication Method of the Server Devices Having the Anycast Address)

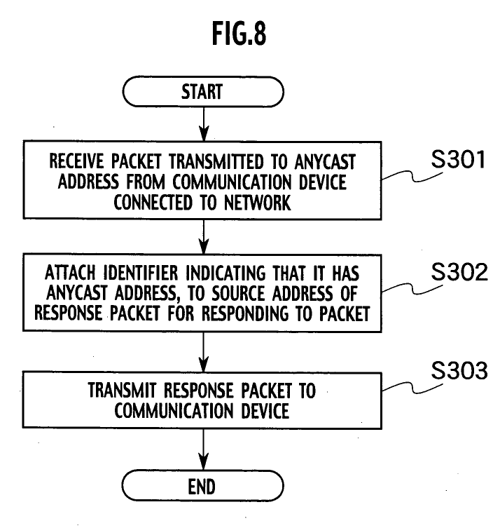

Next, the communication method of the A-server 30a and the B-server 30b will be described with reference to FIG. 8.

(a) At the step S301, the reception unit 36a receives a packet transmitted to the anycast address from the communication devices 10a, 10b, 10c, etc., through the Internet 1.

(b) At the step S302, the identifier attaching unit 36b attaches the identifier indicating that this server device has the anycast address, to the source address of the response packet for responding to the packet.

(c) At the step S303, the transmission unit 36c transmits the response packet with the identifier attached, to the communication devices 10a, 10b, 10c, etc.

According to the above described processing, by attaching the identifier indicating the anycast address communication at the A-server 30a, it becomes possible for the other device to carry out the filtering, so that the security at the equivalent level as the unicast address can be secured for the anycast address.

(Communication Method Using the Communication Devices, the Boundary Router, and the Server Devices)

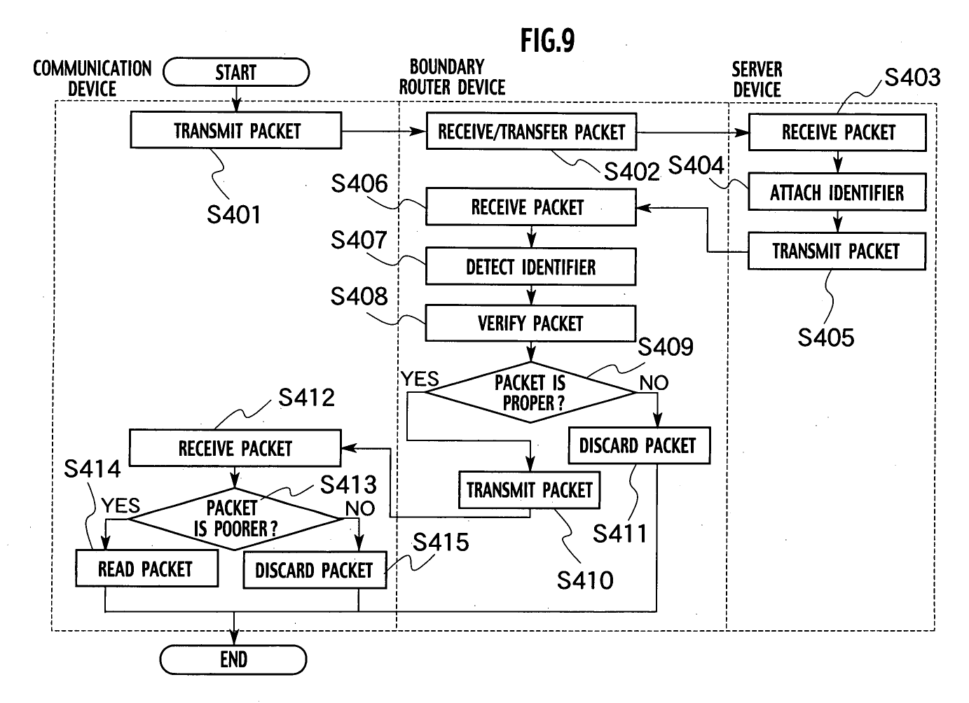

In the following, the process of carrying out transmission and reception of the packet destined to the A-server 30a by using the communication devices 10a, 10b, 10c, etc. shown in FIG. 1 will be described with reference to FIG. 9.

(a) At the step S401, when the packet transmission request is inputted through the input device 11 of the communication devices 10a, 10b, 10c, etc., the transmission unit 16a checks the destination address of the A-server 30a in the header of the packet, and transmits the packet to that destination address. The packet is transmitted to the destination address through the Internet 1. The packet that is received at the first network 7 to which the A-server 30a belongs is transferred to the boundary router 20 and the A-router 3 at the step S402, and eventually transmitted to the A-server 30a at the destination address.

(b) At the step S403, the reception unit 36a of the A-server 30a receives the packet. After that, at the step S404, the identifier attaching unit 36b attaches the identifier to the response packet to be returned. For this identifier, the identifier stored in the identifier memory device 37 is used.

After attaching the identifier, at the step S405, the transmission unit 36c transmits the response packet toward the communication devices 10a, 10b, 10c, etc. The response packet is routed by the A-router 3, and transmitted to the boundary router 20.

(c) At the step S406, when the second reception unit 26c of the boundary router 20 receives the response packet, at the step S407, the detection unit 26d detects the identifier indicating the anycast address from the response packet.

(d) At the step S408, the verification unit 26e verifies whether the detected identifier is proper or not. When the packet is proper as a result of the verification, at the step S410, the second transfer unit 26g transmits the response packet toward the communication devices 10a, 10b, 10c, etc., through the Internet 1. When the packet is improper, that packet is discarded at the step S411.

(e) At the step S412, the reception unit 16b of the communication devices 10a, 10b, 10c, etc. receives the response packet. The first detection unit 16c detects the source address of the received packet, and the second detection unit 16d detects the identifier indicating the anycast address from the response packet.

(f) At the step S413, whether this response packet is transmitted from a proper server, i.e. the A-server 30a, or not is verified according to whether the response packet has the identifier indicating the anycast address or not. When the response packet has the proper identifier, at the step S414, this response packet is read, whereas when the response packet does not have the proper identifier, at the step S415, this response packet is discarded.

According to the above described processing, by attaching the identifier indicating the anycast address communication at the A-server 30a, and carrying out the filtering of this identifier at the communication devices 10a, 10b, 10c, etc. and the boundary router 20, the security at the equivalent level as the unicast address can be secured for the anycast address.

As described, according to the present invention, the tolerance equivalent to that of the unicast address can be obtained for the pretending attack at a time of utilizing the anycast address, so that it is possible to provide a communication device, a boundary router device, a server device, a communication system, a communication method, a routing method, a communication program and a routing program which are capable of enabling communications with unspecified many communication devices or communication terminals by using a plug-and-play function which is the advantage of the anycast address communication, while securing the security at the equivalent level as the unicast address.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A communication device, comprising:
a transmission unit configured to transmit a packet to a prescribed destination address;
a reception unit configured to receive a response packet for responding to the packet transmitted by the transmission unit;
a first detection unit configured to detect a source address contained in the response packet received by the reception unit;
a second detection unit configured to detect an identifier indicating that an anycast address is assigned to another communication device that has the prescribed destination address, which is contained in the response packet, when the source address detected by the first detection unit and the prescribed destination address are different; and
a verification unit configured to verify the response packet, according to the identifier detected by the second detection unit.

2. The communication device of claim 1, wherein the communication device functions as a boundary router device located at a boundary between a first network to which a server device having an anycast address belongs and a second network, and the communication device further comprises:
a second reception unit configured to receive one packet destined to the server device, from another communication device on the second network;
a first transfer unit configured to transfer the one packet to the server device;
a third reception unit configured to receive one response packet for responding to the one packet, from the server device;
a third detection unit configured to detect another identifier indicating that a source address different from the anycast address is attached, which is contained in the one response packet;
a second verification unit configured to verify that the one response packet is a response transmitted from the server device, according to information regarding server devices having the anycast address in the second network which are provided in advance, when the another identifier is detected by the third detection unit;
a transfer control unit configured to control whether or not to transfer the one response packet to the another communication device, according to a verification result of the second verification unit; and
a second transfer unit configured to transfer the one response packet to the another communication device, when the transfer control unit judges that the response packet should be transferred.

3. A server device connected to a first network and having an anycast address, comprising:
a reception unit configured to receive a packet transmitted to the anycast address, from a communication device connected to a second network;
an identifier attaching unit configured to attach to a response packet for responding to the packet an identifier indicating that a source of the response packet has the anycast address; and
a transmission unit configured to transmit the response packet to the communication device.

4. A communication system, comprising:
a server device connected to a first network and having an anycast address;
a communication device connected to a second network; and
a boundary router device located at a boundary between the first network and the second network;
wherein the communication device has:
a first transmission unit configured to transmit a packet to the anycast address; and
a first reception unit configured to receive a response packet for responding to the packet from the server device;
the server device has:
a second reception unit configured to receive the packet transmitted to the anycast address from the communication device;
an identifier attaching unit configured to attach to the response packet for responding to the packet a first identifier indicating that the server device has the anycast address; and
a second transmission unit configured to transmit the communication device to the response packet; and
the boundary router device has:
a third reception unit configured to receive the packet destined to the server device from the communication device;
a first transfer unit configured to transfer the packet to the server device;
a fourth reception unit configured to receive the response packet for responding to the packet from the server device;
a detection unit configured to detect a second identifier indicating that a source address different from the anycast address is attached, which is contained in the response packet;
a verification unit configured to verify that the response packet is a response transmitted from the server device, according to information regarding server devices having the anycast address in the first network which is provided in advance, when the second identifier is detected by the detection unit;
a transfer control unit configured to control whether or not to transfer the response packet to the communication device, according to a verification result of the verification unit; and
a second transfer unit configured to transfer the response packet to the communication device, when the transfer control unit judges that the response packet should be transferred.

5. A communication method at a communication device, comprising:
transmitting a packet to a prescribed destination address;
receiving a response packet for responding to the packet;
detecting a source address contained in the response packet;
detecting an identifier indicating that an anycast address is assigned to another communication device that has transmitted the response packet, which is contained in the response packet, when the source address and the prescribed destination address are different; and
verifying the response packet, according to the identifier.

6. The communication method of claim 5, wherein the communication device functions as a boundary router device located at a boundary between a first network to which a server device having an anycast address belongs and a second network, and the communication method further comprises:
receiving one packet destined to the server device, from another communication device on the second network;
transferring the one packet to the server device;
receiving one response packet for responding to the one packet, from the server device;
detecting another identifier indicating that a source address different from the anycast address is attached, which is contained in the one response packet;
verifying that the one response packet is a response transmitted from the server device, according to information regarding server devices having the anycast address in the second network which are provided in advance, when the another identifier is detected;
controlling whether or not to transfer the one response packet to the another communication device, according to a verification result; and
transferring the one response packet to the another communication device, when it is judged that the one response packet should be transferred.

7. A computer program product for causing a computer to function as a communication device, the computer program product comprising:
a first computer program code for causing the computer to transmit a packet to a prescribed destination address;
a second computer program code for causing the computer to receive a response packet for responding to the packet;
a third computer program code for causing the computer to detect a source address contained in the response packet;
a fourth computer program code for causing the computer to detect an identifier indicating that an anycast address is assigned to another communication device that has transmitted the response packet, which is contained in the response packet, when the source address and the prescribed destination address are different; and
a fifth computer program code for causing the computer to verify the response packet, according to the identifier.

8. The computer program product of claim 7, wherein the computer is caused to function as a routing method at a boundary router device located at a boundary between a first network to which a server device having an anycast address belongs and a second network, and the computer program product further comprises:
a sixth computer program code for causing the computer to receive one packet destined to the server device, from another communication device on the second network;
a seventh computer program code for causing the computer to transfer the one packet to the server device;
an eighth computer program code for causing the computer to receive one response packet for responding to the one packet, from the server device;
a ninth computer program code for causing the computer to detect another identifier indicating that a source address different from the anycast address is attached, which is contained in the one response packet;
a tenth computer program code for causing the computer to verify that the one response packet is a response transmitted from the server device, according to information regarding server devices having the anycast address in the second network which are provided in advance, when the another identifier is detected;
an eleventh computer program code for causing the computer to control whether or not to transfer the one response packet to the another communication device, according to a verification result; and
a twelfth computer program code for causing the computer to transfer the one response packet to the another communication device, when it is judged that the one response packet should be transferred.
